(19) United States
(12) Patent Application Publication
(10) Pub. No.: US 2026/0354362 A1
(43) Pub. Date: Nov. 12, 2026

(54) Fishing Line Guide Ring

(71) Applicant: Weihai Xingtai Jinggong Technology Co., Ltd., Weihai (CN)

(72) Inventor: Lili Meng, Weihai (CN)

(21) Appl. No.: 19/567,404

(22) Filed: Mar. 16, 2026

(30) Foreign Application Priority Data
May 9, 2025 (CN) 202520909495.3

(51) Int. Cl. A01K 87/04

(52) U.S. Cl. CPC A01K 87/04

(57) ABSTRACT

A fishing line guide ring includes support legs and a line guide ring. The line guide ring includes a fixing ring and an inner guide ring, the inner guide ring is embedded inside the fixing ring, the fixing ring includes a fixing outer ring and a fixing inner ring, and the fixing inner ring is arranged inside the fixing outer ring. By providing the inner guide ring within the fixing ring, the fixing ring can provide the necessary support required by the fishing line guide ring, and meanwhile, the inner guide ring can be made of a wear-resistant material, thereby reducing material consumption and extending the service life. By combining the fixing outer ring and the fixing inner ring, different materials can be selected during use, so that the fixing ring can satisfy both the rigid support function and the elastic function required by the fishing line guide ring.

### CROSS REFERENCE TO THE RELATED APPLICATIONS

This application is based upon and claims priority to Chinese Patent Application No. 2025209094953, filed on May 9, 2025, the entire contents of which are incorporated herein by reference.

### TECHNICAL FIELD

The present invention relates to the technical field of fishing tackle, specifically to a fishing line guide ring.

### BACKGROUND

Fishing is a traditional recreational activity popular among the people. To facilitate the reeling in and out of a fishing line, multiple fishing line guide rings are spaced along the length direction of a fishing rod. Existing fishing line guide ring generally includes a frame and a line guide ring. If the line guide ring adopts materials, such as nickel-titanium alloy, to meet elasticity requirements, the overall hardness of the line guide ring will be relatively low, making it prone to abrasion by the fishing line. An abraded groove will further damage the fishing line, even causing it to break. If the line guide ring adopts metallic materials with high hardness to meet abrasion resistance requirements, the fishing line is prone to abrasion. Furthermore, metal sheet stamping is generally used during manufacturing, the line guide ring is easily snagged by debris in environments with abundant branches and weeds, which potentially damages the line guide ring and even the fishing rod. Therefore, how to achieve both high elasticity and abrasion resistance in fishing line guide ring is a problem that needs to be solved by those skilled in the art.

### SUMMARY

To address the aforementioned problems in the prior art, the present invention provides a fishing line guide ring, which ensures that support legs of the fishing line guide ring have high elasticity and are easy to restore to their original shape, and that the line guide ring has good wear resistance when a fishing line passes therethrough, thus extending its service life.

### Technical Solution

To achieve the above objectives, the present invention provides the following technical solution: A fishing line guide ring includes support legs and a line guide ring, the line guide ring includes a fixing ring and an inner guide ring, the inner guide ring is embedded inside the fixing ring, the fixing ring includes a fixing outer ring and a fixing inner ring, and the fixing inner ring is arranged inside the fixing outer ring.

Preferably, the fixing outer ring has openings on both sides, and the fixing inner ring passes through the openings on both sides of the fixing outer ring to form an integral structure with the support legs.

Preferably, the fixing outer ring is a structure capable of enclosing the fixing inner ring.

Preferably, the end of each support leg away from the line guide ring is connected to a base foot or a rod ring.

Preferably, both the fixing outer ring and the fixing inner ring are made of metal, and the fixing inner ring and the support legs each are made of nickel-titanium alloy.

Preferably, the fixing outer ring is a structure capable of partially enclosing the fixing inner ring, and the fixing outer ring covers the outer side of the fixing inner ring.

Preferably, the cross-sectional shape of the fixing inner ring can be set to a circular shape or a square shape.

### Beneficial Effects

Compared with the prior art, the present invention provides a fishing line guide ring, which has the following beneficial effects:

By providing an inner guide ring within a fixing ring, the fixing ring can provide the necessary support required by the fishing line guide ring, and meanwhile, the inner guide ring can be made of a wear-resistant material, thereby reducing material consumption and extending the service life of the fishing line guide ring.

By combining a fixing outer ring and a fixing inner ring, different materials can be selected during use, so that the fixing ring can satisfy both the rigid support function and the elastic function required by the fishing line guide ring.

The integral structure formed by the fixing inner ring and the support legs can reduce manufacturing costs and improve the overall appearance. The one-piece molding of nickel-titanium alloy gives the fishing line guide ring high elasticity and makes it easy to return to its original shape.

### BRIEF DESCRIPTION OF THE DRAWINGS

FIG. 1 is a schematic structural diagram of a fishing line guide ring;

FIG. 2 is a schematic structural diagram of FIG. 1 with the upper half of the cross-section AA removed;

FIG. 3 is a schematic diagram showing the longitudinal cross-sectional structure of the present invention;

FIG. 4 and FIG. 6 are schematic diagrams showing the lateral cross-section structure in FIG. 1, where the cross-sectional shape of the fixing inner ring is circular shape;

FIG. 5 and FIG. 7 are schematic diagrams showing the lateral cross-section structure in FIG. 1, where the cross-sectional shape of the fixing inner ring is square shape.

In the figures: 1. line guide ring; 2. support leg; 3. base foot; 4. inner guide ring; 5. fixing ring; 51. fixing outer ring; 52. fixing inner ring; 53. opening.

### DETAILED DESCRIPTION OF THE EMBODIMENTS

The technical solutions of the present invention will be clearly and completely described below with reference to the accompanying drawings of the embodiments of the present invention. Obviously, the described embodiments are only some embodiments of the present invention, rather than all. Based on the embodiments of the present invention, all other embodiments obtained by those of ordinary skill in the art without creative effort are within the protection scope of the present invention.

In the description of the present invention, it should be understood that the orientation or positional relationships indicated by the terms “center” “longitudinal” “lateral” “upper” “lower” “front” “rear” “left” “right” “vertical” “horizontal” “top” “bottom” “inner”, “outer” etc., are based on the orientation or positional relationships shown in the accompanying drawings and are only for the convenience of describing the present invention and simplifying the description, and do not indicate or imply that the device or element referred to must have a specific orientation, or be constructed and operated in a specific orientation, and therefore should not be construed as a limitation of the present invention. Furthermore, the terms “first”, “second”, etc., are used for descriptive purposes only and should not be construed as indicating or implying relative importance or implicitly specifying the number of indicated technical features. Thus, feature defined with “first”. “second”, etc., may explicitly or implicitly include one or more of the feature. In the description of the present invention, unless otherwise stated, “a plurality of/multiple” means two or more.

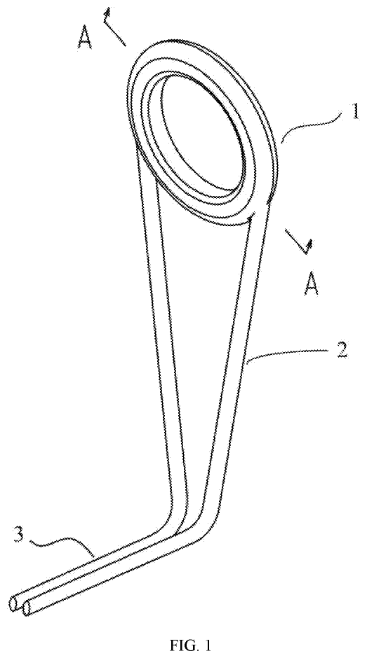

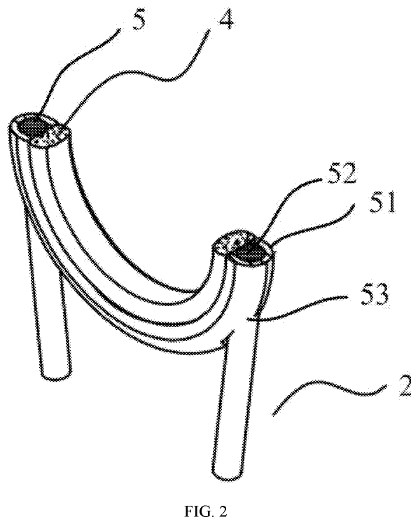

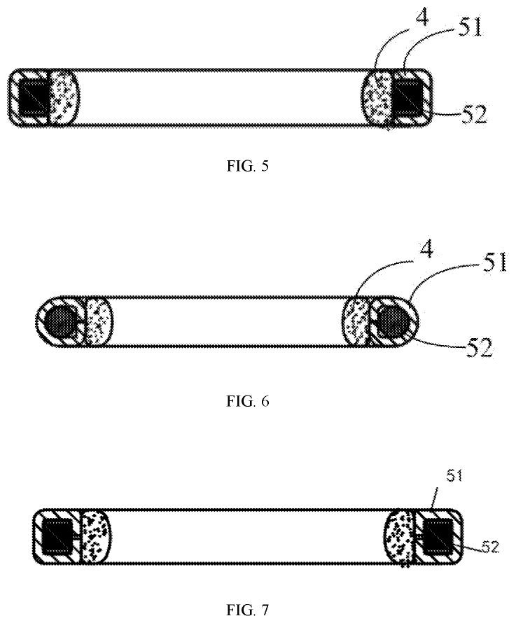

Referring to FIGS. 1-5, the present invention provides a technical solution for a fishing line guide ring:

Embodiment 1: The fishing line guide ring includes support legs 2 and a line guide ring 1. The support legs 2 are fixedly connected to the line guide ring 1. The line guide ring 1 includes a fixing ring 5 and an inner guide ring 4. The inner guide ring 4 is embedded inside the fixing ring 5. The inner guide ring 4 is made of a wear-resistant material, such as a ceramic material, with high hardness, which improves the wear resistance of the fishing line guide ring. When in use, a fishing line passes through the inner guide ring. Due to its high hardness, it is not easily corroded, thereby extending the service life of the fishing line guide ring.

The fixing ring 5 includes a fixing outer ring 51 and a fixing inner ring 52, and the fixing inner ring 52 is located inside the fixing outer ring 51. The fixing ring mainly serves a supporting and fixing function. The provision of the fixing inner ring within the fixing outer ring allows the selection of different materials for the fixing outer ring and the fixing inner ring according to actual needs. Specifically, both the fixing outer ring 51 and the fixing inner ring 52 are made of metal, which can well meet strength requirements and provide good fixing effect. The fixing outer ring can be made of stainless steel or titanium alloy, possessing a certain strength and providing a fixing and supporting function. The fixing inner ring can be made of nickel-titanium alloy, which has low rigidity and high elasticity, allowing the fishing line guide ring to easily recover after deformation. This satisfies both the rigid support function and the elastic function required by the fishing line guide ring.

The end of each support leg 2 away from the line guide ring 1 is connected to a base foot 3, and all base feet 3 are located on the same side of the fixing ring 5. The arrangement of the base feet on the same side of the fixing ring allows the formation of a single-sided base feet fishing line guide ring, which can be fixed to a fishing rod by binding the base feet to the fishing rod.

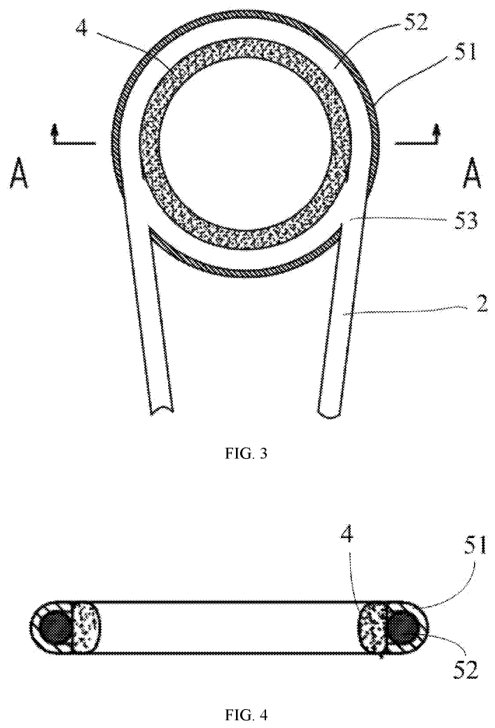

As shown in FIG. 3, the fixing outer ring 51 has openings 53 on both sides, and the fixing inner ring 52 passes through the openings 53 on both sides of the fixing outer ring 51 to form an integral structure with the support legs 2. The use of an integral structure of the fixing inner ring and the support legs can reduce manufacturing costs and improve the overall appearance. The fixing inner ring 52 and the support legs 2 each are made of nickel-titanium alloy, and the integral structure also increases the overall elasticity of the fishing line guide ring.

As shown in FIG. 6 and FIG. 7, the fixing outer ring 51 is a structure capable of fully enclosing the fixing inner ring 52. The fixing inner ring is wrapped inside the fixing outer ring, which can provide good protection for the fixing inner ring and extend its service life.

The fixing inner ring 52 can adopt different cross-sectional shapes, such as circular or square shape, to meet different performance requirements, such as strength, of the fishing line guide ring.

Embodiment 2: The difference between Embodiment 2 and Embodiment 1 is that the end of each support leg 2 away from the line guide ring 1 is connected to the base foot 3, and the base feet are located on different sides of the fixing ring 5. The arrangement of the base feet on different sides of the fixing ring allows the formation of a double-sided base feet fishing line guide ring, enhancing the overall fixing effect of the fishing line guide ring.

By adopting the above technical solution, the fixing inner ring and the support legs each are made of nickel-titanium alloy, which improves the elasticity of the fishing line guide ring, making it less prone to damage during use and easy to restore to its original shape.

Embodiment 3: The difference between Embodiment 3 and Embodiment 1 is that the fixing outer ring 51 is a structure capable of partially enclosing the fixing inner ring 52. The fixing outer ring 51 covers the outer side of the fixing inner ring 52, and the inner side of the fixing inner ring 52 is in contact with the inner guide ring 4. This design can protect the outside of the fixing inner ring and reduce the consumption of material used for the fixing outer ring.

Embodiment 4: The difference between Embodiment 4 and Embodiments 1, 2 and 3 above is that the support legs are not connected to the base feet, but instead, connected to a metal or plastic rod ring fitted on the fishing rod body.

The above are merely specific embodiments of the present invention, but the technical features of the present invention are not limited thereto. Any simple changes, equivalent substitutions, or modifications made based on the present invention to solve essentially the same technical problems and achieve essentially the same technical effects are all covered within the protection scope of the present invention.

What is claimed is:

1. A fishing line guide ring, comprising support legs and a line guide ring, wherein the line guide ring comprises a fixing ring and an inner guide ring, the inner guide ring is embedded inside the fixing ring, the fixing ring comprises a fixing outer ring and a fixing inner ring, and the fixing inner ring is arranged inside the fixing outer ring.

2. The fishing line guide ring according to claim 1, wherein the fixing outer ring has openings on both sides, and the fixing inner ring passes through the openings on both sides of the fixing outer ring to form an integral structure with the support legs.

3. The fishing line guide ring according to claim 1, wherein the fixing outer ring is a structure capable of enclosing the fixing inner ring.

4. The fishing line guide ring according to claim 1, wherein an end of each of the support legs away from the line guide ring is connected to a base foot or a rod ring.

5. The fishing line guide ring according to claim 1, wherein both the fixing outer ring and the fixing inner ring are made of metal, and the fixing inner ring and the support legs each are made of nickel-titanium alloy.

6. The fishing line guide ring according to claim 1, wherein the fixing outer ring is a structure capable of partially enclosing the fixing inner ring, and the fixing outer ring covers an outer side of the fixing inner ring.

7. The fishing line guide ring according to claim 1, wherein a cross-sectional shape of the fixing inner ring can be set to a circular shape or a square shape, and an enclosing form is a full enclosure or a partial enclosure.
